(19) United States
(12) Patent Application Publication
(10) Pub. No.: US 2026/0200444 A1
(43) Pub. Date: Jul. 16, 2026

(54) BRAKING SYSTEM FOR A VEHICLE AND A WHEEL BRAKE DEVICE

(71) Applicant: MERCEDES-BENZ GROUP AG, Stuttgart (DE)

(72) Inventors: Alexander VON GAISBERG-HELFENBERG, Beilstein (DE); Timo SCHMIDT, Waldenbuch (DE); Jochen HAEFNER, Lorch (DE)

(21) Appl. No.: 19/135,438

(22) PCT Filed: Nov. 17, 2023
(86) PCT No.: PCT/EP2023/082214

§ 371 Date: Jun. 4, 2025

(30) Foreign Application Priority Data
Dec. 5, 2022 (DE) 10 2022 004 536.2

(51) Int. Cl. B60T 1/087; B60K 7/00; F16D 57/02; F16D 65/16; F16D 121/18; F16H 57/02

(52) U.S. Cl. CPC B60T 1/087; B60K 7/0007; F16D 57/02; F16D 65/16; F16H 57/02; F16D 2121/18; F16H 2057/02034; F16H 2057/02052

(57) ABSTRACT

A braking system for a vehicle includes a brake for at least one vehicle wheel. The braking system works without an additional brake hydraulics system. The brake is filled with a viscous fluid causing friction in the brake, which generates a braking force. The brake filled with the viscous fluid is arranged in an encapsulated container.

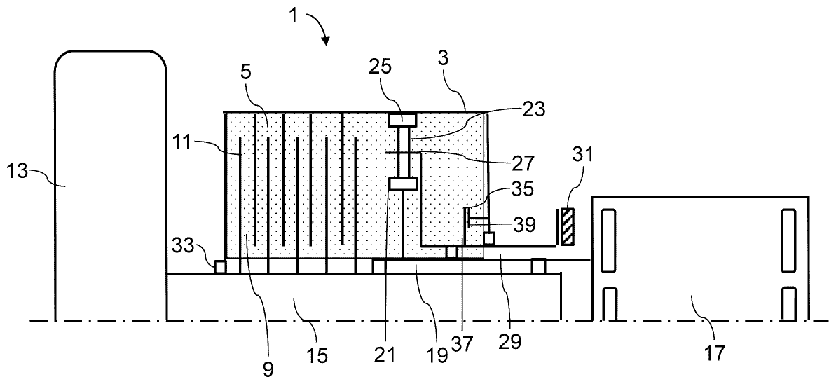

### BACKGROUND AND SUMMARY OF THE INVENTION

Exemplary embodiments of the invention relate to a braking system for a vehicle, preferably an electrically driven vehicle, comprising a brake for at least one vehicle wheel and a wheel brake device.

A sustained-action brake for a motor vehicle, in particular for a heavy goods vehicle, is known from DE 1 215 013 B. A hydrodynamic brake arranged on a differential gearing of a vehicle axle is used as a sustained-action brake. A step-up toothed drive, which drives a rotor of the hydrodynamic brake in order to convey a braking fluid, is arranged on the crown wheel of the differential gear. An adjustable scoop tube scoops out the contents of the brake up to a desired diameter, to regulate the braking power. The braking effect is therefore set by the pressure of the brake fluid located in the brake.

Exemplary embodiments of the invention are directed to a braking system for a vehicle and a wheel brake device, which works without an additional brake hydraulics system.

Further features, application possibilities and advantages of the invention result from the following description, and the explanation of exemplary embodiments of the invention, which is represented in the FIGURE.

The braking system explained above comprises a brake for at least one vehicle wheel, for creating a braking force, wherein the brake is filled with a viscous fluid causing friction in the brake, wherein the brake filled with the viscous fluid is arranged in an encapsulated container. An additional brake hydraulics system is omitted due to the arrangement of the fluid in a completely enclosed container, whereby construction volume and weight of the braking system is reduced. As the brake acts by means of fluid friction at its walls as a result of the brake being filled with the viscous fluid due to the inertia occurring when the fluid moves, the brake works without wear and does not release particles to the surroundings. Thus, it is not necessary to replace the viscous fluid.

Advantageously, the brake has several mutually engaging intermediate walls, wherein the viscosity of the fluid expanding between the intermediate walls is selected as a function of the distance between the opposite intermediate walls. The fluid friction and thus the braking torque of the brake is determined via the distance between the intermediate walls.

In one embodiment, the brake is arranged close to an electric drive unit of the wheel and preferably is an integral component of the drive unit. Thus, a compact drive/brake unit can be produced, which requires little installation space. Furthermore, the wheel-side unsprung mass is reduced by the positioning of the brake close to the drive unit, which increases the driving comfort of the vehicle.

In one variant, a gearbox coupled to the electric drive unit and an auxiliary drive for initiating the braking effect are arranged on the drive unit. The auxiliary drive has the task of initiating or preventing the braking effect.

A further aspect of the invention relates to a wheel brake device for a vehicle, comprising a brake arranged in a housing and filled with a viscous fluid, wherein the housing is connected to a wheel shaft for conjoint rotation and the wheel shaft can be driven by a hollow shaft coupled to an electric drive unit. Such a wheel brake device works without an additional brake hydraulics system, which reduces the production costs. As the housing, drive shaft, and output shaft rotate at the same rotational speed during operation, this results in zero brake torque when the brake is released, as fluid friction does not occur. Due to the fluid friction, which is brought about by the shearing action in the viscous fluid, a rotational speed difference results between the wheel shaft and hollow shaft, which initiates a braking effect at the wheel.

It is an advantage when a gearbox is positioned in the housing comprising the brake, which gearbox is connected to an auxiliary drive via an auxiliary hollow shaft extending partially on the outside on the hollow shaft in order to apply a deceleration force. Thus, the braking effect can be initiated by a simple design measure.

In one embodiment, the gearbox is designed as a planetary gearbox, the sun of which is coupled to the hollow shaft connected by the electric drive unit, while the housing supports the ring gear of the planetary gearbox and the planetary gear carrier is connected to the auxiliary hollow shaft actuated by the auxiliary drive. Planetary gearboxes are well known and are produced in large numbers in mass production. Therefore, they are particularly cost-effective, which reduces the production costs of the wheel brake device.

In one variant, the brake has several comb-like mutually engaging intermediate walls, wherein the viscosity of the fluid expanding between the intermediate walls is selected as a function of the distance between the opposite intermediate walls. The comb-like mutually engaging intermediate walls increase the effective area for the fluid friction in a small installation space, whereby the performance of the wheel brake device is increased.

In one embodiment, the coaxially extending shafts are rotatably supported against each other and/or against the housing. Therefore, all shafts and the housing can be rotated against each other freely, which supports the functionality of the wheel brake device in a small installation space.

Advantageously, the planetary gearbox is sometimes non-rotatably mounted on the housing via a coupling coupled to the auxiliary hollow shaft. Therefore, an unbraked propulsive driving operation can be performed in electrically driven vehicles, in which the electrical high-voltage drive of the vehicle is in a recuperation mode. In particular, this has an impact when driving downhill.

Advantageously, the driven wheel is aerodynamically designed. This is possible, as there is no requirement to cool the wheel brake device. Thus, the vehicle has a longer range and improved efficiency.

Further advantages, features and characteristics result from the following description, in which at least one exemplary embodiment is described in more detail—where appropriate by referring to the drawing. Features described and/or depicted can on their own and/or in any significant combination form the subject matter of the invention, where appropriate also independently of the claims, and in particular can additionally also be the subject matter of one or more separate applications. Identical, similar and/or functionally identical parts are provided with identical reference numerals.

### BRIEF DESCRIPTION OF THE SOLE DRAWING FIGURE

The sole drawing FIGURE shows an exemplary embodiment of the braking system according to the invention having a wheel brake device.

### DETAILED DESCRIPTION

The sole drawing FIGURE illustrates an exemplary embodiment of a braking system of a vehicle in the form of a wheel brake device. The wheel brake device 1 comprises a housing 3, in which the brake 5 and a gearbox 7 are arranged. The housing 3 is completely filled with a viscous fluid 9 and is completely encapsulated with respect to the surroundings, so that the viscous fluid 9 cannot escape. The brake 5 consists of several discs 11, mutually engaging as comb-like intermediate walls, between which the viscous fluid 9 expands.

The brake 5 is connected to a wheel solid shaft 15, driving a wheel 13 of the vehicle, for conjoint rotation. The housing 3 is rotatably mounted on the wheel solid shaft 15 by means of a roller bearing. A hollow shaft 19 extends around the wheel solid shaft 15, which is driven by an electric drive unit 17. In this case, the hollow shaft 19 is coupled to the sun 21 of a planetary gearbox 23, whose ring gear 25 is supported by the housing 3. The planetary gear carrier 27 of the planetary gearbox 23 is connected to an auxiliary hollow shaft 29, which in turn engages around the hollow shaft 19 and can be braked by an electromechanically actuated auxiliary brake 31. The wheel solid shaft 15, the hollow shaft 19, and the auxiliary hollow shaft 29 are supported against each other and against the housing 3 with the roller bearings 33 and form a coaxial system.

When the vehicle is in operation, a torque created by the electric drive unit 17 is transmitted to the wheel solid shaft 15 from the hollow shaft 19 designed as an output drive shaft, whereby a wheel 13 is driven. The wheel solid shaft 15 rotates with the rotational speed of the hollow shaft 19. The rotational speed difference is zero. The planetary gear carrier 27 is decelerated by means of the auxiliary brake 31 during the braking, which is initiated by the driver of the vehicle actuating a brake pedal or by a signal generated automatically by the braking system. The deceleration takes place by the brake signal activating the auxiliary brake 31. The deceleration torque is transmitted to the planetary gear carrier 27 of the planetary gearbox 23 via the auxiliary hollow shaft 29. In the process, the viscous fluid expanding between the discs 11 creates fluid friction at the discs, which slows the rotational movement of the wheel shaft 15. Therefore, a difference in rotational speed between the wheel shaft 15 and the housing 3 arises, which leads to a brake torque being formed between the hollow shaft 19 and the wheel solid shaft 15, whereby the wheel 13 is braked.

During a propulsive driving operation of the vehicle driven by an electric drive, the planetary gear carrier 27 is fixedly coupled to the housing 3 by a coupling 35 arranged inside the housing 3, the first coupling disc 37 of which coupling is connected to the auxiliary hollow shaft 29 and the second coupling disc 39 of which coupling is coupled to the housing 3 for conjoint rotation. Thus, the vehicle can continue to roll without being braked.

1-10. (canceled)

11. A braking system for a vehicle, the braking system comprising:
a brake configured to brake at least wheel of the vehicle,
wherein the brake is filled with a viscous fluid, which causes friction in the brake to generate a braking force, and
wherein the brake filled with the viscous fluid is arranged in an encapsulated container.

12. The braking system of claim 11, wherein the brake has several mutually engaging intermediate walls, wherein a viscosity of the fluid expanding between the intermediate walls is selected as a function of a distance between opposite intermediate walls.

13. The braking system of claim 11, wherein the brake is an integral component of an electric drive unit of the vehicle.

14. The braking system of claim 13, wherein a gearbox is coupled to the electric drive unit, wherein the gearbox and an auxiliary drive are arranged on the electric drive unit, wherein the auxiliary drive is configured to initiate a braking effect.

15. A wheel brake device for a vehicle, the wheel brake device comprising:
a housing filled with a viscous fluid;
a brake arranged in the housing,
wherein the housing is connected to a wheel shaft to conjointly rotate, and
wherein the wheel shaft is drivable by a hollow shaft coupled to an electric drive unit.

16. The wheel brake device of claim 15, further comprising:
a gearbox is positioned in the housing, wherein the is connected to an auxiliary drive via an auxiliary hollow shaft extending partially on an outside on the hollow shaft to apply a deceleration force.

17. The wheel brake device of claim 16, wherein the gearbox is designed is a planetary gearbox, wherein a sun of the planetary gearbox is coupled to the hollow shaft connected by the electric drive unit, while the housing supports a ring gear of the planetary gearbox, and wherein a planetary gear carrier of the planetary gearbox is connected to the auxiliary hollow shaft actuated by the auxiliary drive.

18. The wheel brake device of claim 15, wherein the brake has several comb-like mutually engaging intermediate walls, wherein the viscosity of the fluid expanding between the intermediate walls is selected as a function of the distance between the opposite intermediate walls.

19. The wheel brake device of claim 16, wherein the wheel shaft, the hollow shaft, and the auxiliary hollow shaft are coaxially extending shafts rotatably supported against each other or against the housing.

20. The wheel brake device of claim 16, wherein, in a drive-free driving mode, the planetary gearbox is non-rotatably mounted on the housing via a state of a coupling coupled to the auxiliary hollow shaft.
